(19) United States
(12) Patent Application Publication
(10) Pub. No.: US 2014/0246949 A1
(43) Pub. Date: Sep. 4, 2014

(54) MEMS DEVICE, ELECTRONIC DEVICE, ELECTRONIC APPARATUS, AND MOVING OBJECT

(71) Applicant: Seiko Epson Corporation, Tokyo (JP)

(72) Inventor: Akinori Yamada, Ina (JP)

(73) Assignee: Seiko Epson Corporation, Tokyo (JP)

(21) Appl. No.: 14/190,269

(22) Filed: Feb. 26, 2014

(30) Foreign Application Priority Data
Mar. 1, 2013 (JP) 2013-040409

(51) Int. Cl. H02N 1/00

(52) U.S. Cl. CPC H02N 1/00
USPC 310/308

(57) ABSTRACT

A MEMS device includes a substrate and a vibrator. The vibrator includes a first conductive layer and a second conductive layer. The first conductive layer is arranged on a principal plane of the substrate and includes a first fixed electrode. The second conductive layer includes an upper electrode and a support electrode. The upper electrode is spaced apart from the first fixed electrode, has an area overlapping the first fixed electrode. The support electrode connects a second fixed electrode connected to the principal plane with one edge of the upper electrode. The upper electrode includes a plurality of driving electrodes divided by a slit-shaped notch extending in a direction from a vibration tip portion to a vibration base portion where the vibration base portion is the one edge of the upper electrode and the vibration tip portion is the other edge.

### BACKGROUND

1. Technical Field

The present invention relates to a MEMS device, an electronic device, an electronic apparatus, and a moving object.

2. Related Art

In recent years, the demand for MEMS (Micro-Electro-Mechanical Systems) devices using a semiconductor manufacturing method as one of precision machining techniques is expanding. For example, as shown in JP-A-2012-85085, a MEMS vibrator including a first electrode formed on a substrate and a second electrode including a beam portion arranged to face the first electrode is disclosed. In the MEMS vibrator, the beam portion is vibrated by an electrostatic force generated between the first electrode and the second electrode.

In the MEMS vibrator shown in JP-A-2012-85085, however, so-called vibration leakage occurs in which vibration of the beam portion leaks to the substrate via a support portion that supports the beam portion, failing to obtain a desired vibration efficiency.

### SUMMARY

An advantage of some aspects of the invention is to obtain a MEMS device that can suppress vibration leakage and suppress a reduction in vibration efficiency.

The invention can be implemented as the following forms or application examples.

### Application Example 1

This application example is directed to a MEMS device including: a substrate; and a vibrator, wherein the vibrator includes a first fixed electrode located on the substrate, an upper electrode spaced apart from the first fixed electrode and having an area overlapping the first fixed electrode as viewed in a normal direction of a principal plane of the substrate, and a support electrode connected to one edge of the upper electrode, and the upper electrode includes a plurality of driving electrodes divided by a slit-shaped notch arranged in a direction from the other edge to the support electrode.

According to the MEMS device of this application example, the plurality of driving electrodes divided by the slit-shaped notch arranged in the upper electrode are excited, so that vibration leakage to the substrate via the support electrode can be suppressed. Accordingly, it is possible to obtain the MEMS device including the MEMS vibrator having a high Q-value and a high vibration efficiency.

### Application Example 2

This application example is directed to a MEMS device including: a substrate; and a vibrator, wherein the vibrator includes a first conductive layer arranged on a principal plane of the substrate and including a first fixed electrode, and a second conductive layer including an upper electrode and a support electrode, the upper electrode being spaced apart from the first fixed electrode, having an area overlapping the first fixed electrode as viewed in a normal direction of the principal plane, and extending along the principal plane, the support electrode connecting a second fixed electrode connected to the principal plane with one edge of the upper electrode, and supporting the upper electrode, and the upper electrode includes a plurality of driving electrodes divided by a slit-shaped notch arranged in a direction from a vibration tip portion to a vibration base portion, the vibration base portion being the one edge of the upper electrode, the vibration tip portion being the other edge.

According to the MEMS device of this application example, the plurality of driving electrodes divided by the slit-shaped notch arranged in the upper electrode are excited, so that vibration leakage to the substrate via the support electrode and the second fixed electrode can be suppressed. Accordingly, it is possible to obtain the MEMS device including the MEMS vibrator having a high Q-value and a high vibration efficiency.

### Application Example 3

This application example is directed to the application example described above, wherein the first fixed electrode includes a plurality of electrode portions overlapping the plurality of driving electrodes of the second conductive layer as viewed in the normal direction of the principal plane.

According to this application example, the plurality of driving electrodes can be individually controlled, so that the MEMS vibrator having a high Q-value with suppressed vibration leakage has a higher vibration efficiency. With this configuration, it is possible to obtain the MEMS device including the MEMS vibrator having a high Q-value and a high vibration efficiency.

### Application Example 4

This application example is directed to the application example described above, wherein an end of the notch in the vibration base portion direction is present in the area of the support electrode.

According to this application example, since the end of the notch at the vibration base portion is away from the second fixed electrode, and the influence of vibration is less likely to be exerted on the substrate, vibration leakage is suppressed. Therefore, it is possible to obtain the MEMS device including the MEMS vibrator having a high Q-value.

### Application Example 5

This application example is directed to the application example described above, wherein an end of the notch in the vibration base portion direction is present in the area of the upper electrode.

According to this application example, since the end of the notch at the vibration base portion is away from the second fixed electrode, and the influence of vibration is less likely to be exerted on the substrate, so that vibration leakage is suppressed. Therefore, it is possible to obtain the MEMS device including the MEMS vibrator having a high Q-value.

### Application Example 6

This application example is directed to the application example described above, wherein the notch is arranged at two or more even numbered places, and vibration directions of the driving electrodes adjacent to each other with the notch interposed therebetween are opposite from each other.

According to this application example, since the vibration directions of the driving electrodes adjacent to each other are opposite from each other, vibrations at the vibration base portion are cancelled out, so that vibration leakage can be suppressed. Accordingly, it is possible to obtain the MEMS device including the MEMS vibrator having a high Q-value.

### Application Example 7

This application example is directed to the application example described above, wherein the notch is arranged at two places to provide a first driving electrode arranged between the notches and two second driving electrodes each adjacent to the first driving electrode with the notch interposed therebetween, and the condition: 0.1≦W1/W2≦2.0 is satisfied where W1 is the width of the first driving electrode and W2 is the width of the second driving electrode.

According to this application example, vibrations of the first driving electrode and the two second driving electrodes are balanced, so that it is possible to obtain the MEMS device including the MEMS vibrator having a high Q-value.

### Application Example 8

This application example is directed to the application example described above, wherein the condition: 1.4≦W1/W2≦1.8 is satisfied.

According to this application example, vibrations of the first driving electrode and the two second driving electrodes are balanced, so that it is possible to obtain the MEMS device including the MEMS vibrator having a high Q-value.

### Application Example 9

This application example is directed to an electronic device including: the MEMS device described above; and a control circuit including a circuit driving the MEMS device.

According to the electronic device of this application example, since the electronic device includes the MEMS device with suppressed vibration leakage, capable of stably extracting a desired resonant frequency, and having a high Q-value, the desired resonant frequency can be stably extracted.

### Application Example 10

This application example is directed to an electronic apparatus including the MEMS device described above.

According to the electronic apparatus of this application example, the electronic apparatus includes the MEMS device with suppressed vibration leakage, capable of stably extracting the desired resonant frequency, and having a high Q-value, so that a stable operation of the electronic apparatus can be obtained.

### Application Example 11

This application example is directed to a moving object including the MEMS device described above.

According to the moving object of this application example, the moving object includes the MEMS device with suppressed vibration leakage, capable of stably extracting the desired resonant frequency, and having a high Q-value, so that a stable operation can be obtained.

### BRIEF DESCRIPTION OF THE DRAWINGS

The invention will be described with reference to the accompanying drawings, wherein like numbers reference like elements.

FIGS. 1A to 1C show a MEMS device according to a first embodiment, in which FIG. 1A is a plan view; FIG. 1B is a cross-sectional view of a portion A-A′ shown in FIG. 1A; and FIG. 1C is a cross-sectional view of a portion B-B′ shown in FIG. 1A and a portion C-C′ shown in FIG. 1B.

FIGS. 2A and 2B are diagrammatic views explaining the operation of a MEMS vibrator included in the MEMS device according to the first embodiment.

FIGS. 3A to 3D explain forming conditions of the MEMS vibrator included in the MEMS device according to the first embodiment, in which FIG. 3A is a plan view; FIGS. 3B and 3C are cross-sectional views of a portion D-D′ shown in FIG. 3A; and FIG. 3D is a graph showing a Q-value distribution.

FIGS. 4A to 4C explain forming conditions of the MEMS vibrator included in the MEMS device according to the first embodiment, in which FIG. 4A is a plan view; FIG. 4B is a graph showing a Q-value distribution; and FIG. 4C is a plan view showing another form of the MEMS vibrator.

FIGS. 5A to 5C are plan views showing other forms of the MEMS vibrator.

FIG. 6 is a cross-sectional view showing an electronic device according to a second embodiment.

FIG. 7 is an external view showing a smartphone as an electronic apparatus according to a third embodiment.

FIG. 8 is an external view showing a digital still camera as an electronic apparatus according to the third embodiment.

FIG. 9 is an external view showing an automobile as a moving object according to a fourth embodiment.

### DESCRIPTION OF EXEMPLARY EMBODIMENTS

Hereinafter, embodiments according to the invention will be described with reference to the drawings.

### First Embodiment

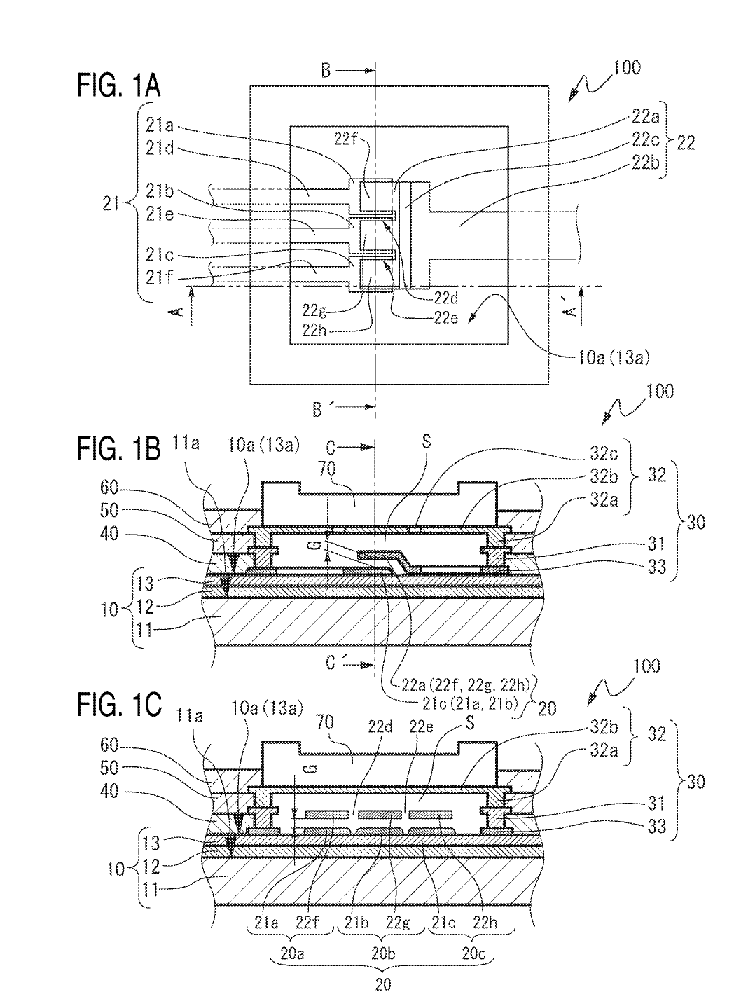

FIGS. 1A to 1C show a MEMS device according to a first embodiment, in which FIG. 1A is a plan view in a state where a covering layer and a lid, both described later, are removed; FIG. 1B is a cross-sectional view of a portion A-A′ shown in FIG. 1A; and FIG. 1C is a cross-section of a portion B-B′ shown in FIG. 1A, which is also a cross-sectional view of a cross-section of a portion C-C′ in FIG. 1B. As shown in FIGS. 1B and 1C, the MEMS device 100 according to the embodiment includes a substrate 10 composed of a wafer substrate 11, a first oxide film 12 arranged on a principal plane 11a of the wafer substrate 11, and a nitride film 13 arranged on the first oxide film 12. The wafer substrate 11 is a silicon substrate, and the MEMS device 100 is manufactured using a semiconductor manufacturing apparatus and a semiconductor manufacturing method.

On a principal plane 10a of the substrate 10, that is, on a surface 13a of the nitride film 13, a first conductive layer 21 and a second conductive layer 22 are arranged. As shown in FIG. 1A, the first conductive layer 21 includes, as a first fixed electrode on the surface of the principal plane 10a, lower electrodes 21a, 21b, and 21c as three electrode portions and lower electrode wiring portions 21d, 21e, and 21f that connect the lower electrodes 21a, 21b, and 21c with an external wiring (not shown).

The second conductive layer 22 includes an upper electrode 22a arranged to face the lower electrodes 21a, 21b, and 21c, an upper electrode wiring portion 22b arranged as a second fixed electrode on the principal plane 10a, and a support electrode 22c that maintains the upper electrode 22a spaced apart in a face-to-face manner from the lower electrodes 21a, 21b, and 21c and connects with the upper electrode wiring portion 22b. The upper electrode wiring portion 22b is connected to an external wiring (not shown). Notches 22d and 22e are arranged in the upper electrode 22a. Due to the notches 22d and 22e, three driving electrodes 22f, 22g, and 22h are arranged. The first conductive layer 21 and the second conductive layer 22 are arranged by patterning conductive polysilicon using photolithography. Although an example of using polysilicon for the first conductive layer 21 and the second conductive layer 22 is shown in the embodiment, the first conductive layer 21 and the second conductive layer 22 are not limited to polysilicon.

The lower electrodes 21a, 21b, and 21c included in the first conductive layer 21 and the driving electrodes 22f, 22g, and 22h of the upper electrode 22a included in the second conductive layer 22 are arranged to face each other as shown in FIGS. 1A and 1C, thereby constituting a MEMS vibrator 20 including a gap G as a space in which the driving electrodes 22f, 22g, and 22h are movable. An AC charge is applied from an external driver (not shown) to the MEMS vibrator 20, so that the driving electrodes 22f, 22g, and 22h are vibrated by an electrostatic force.

The MEMS vibrator 20 is arranged so as to be accommodated in a space S arranged on the principal plane 10a of the substrate 10. The space S is formed as follows. The first conductive layer 21 and the second conductive layer 22 are formed, and thereafter, a second oxide film 40 is formed. A hole through which a lowermost layer 33 of a space wall portion 30 described later is exposed is formed in the second oxide film 40. The lowermost layer 33 is formed using polysilicon simultaneously with the formation of the first conductive layer 21 and the second conductive layer 22 such that the lowermost layer 33 is connected to the first conductive layer 21 and the second conductive layer 22, and a first wiring layer 31 is formed by patterning using photolithography.

Further, a third oxide film 50 is formed on the second oxide film 40. A hole through which the first wiring layer 31 is exposed is formed in the third oxide film 50, and a second wiring layer 32 is formed by patterning using photolithography. The second wiring layer 32 includes a wall portion 32a constituting the uppermost layer of the space wall portion 30 described later and a lid 32b constituting the space S for accommodating the MEMS vibrator 20. Further, the lid 32b of the second wiring layer 32 includes openings 32c for release etching the second oxide film 40 and the third oxide film 50 that are located in the area of the space S and formed in the manufacturing process for forming the space S.

Next, a protective film 60 is formed so as to expose the openings 32c of the second wiring layer 32, an etchant for etching the second oxide film 40 and the third oxide film 50 is introduced through the openings 32c, and the space S is formed by release etching. The space S is an area surrounded by the space wall portion 30 formed of the lowermost layer 33, the first wiring layer 31, and the second wiring layer 32.

The gap G disposed in the MEMS vibrator 20 is formed by release etching in the formation of the space S described above. That is, after forming the first conductive layer 21, a fourth oxide film (not shown) is formed on the lower electrode 21a, and the upper electrode 22a is formed on the fourth oxide film. Then, the fourth oxide film is removed by release etching together with the second oxide film 40 and the third oxide film 50, so that the gap G is formed. The second oxide film 40 and the third oxide film 50 that are removed by the release etching described above in the area corresponding to the space S, and the fourth oxide film are called as sacrificial layers.

When the release etching is finished and the space S is formed, a covering layer 70 is formed to cover the lid 32b of the second wiring layer 32 not covered with the protective film 60 and to seal the openings 32c. With this configuration, the space S is hermetically sealed. For preventing an increase in air resistance generated due to the vibrations of the driving electrodes 22f, 22g, and 22h, a high vacuum is preferably established in the space S. However, a low vacuum or atmospheric pressure may be established therein.

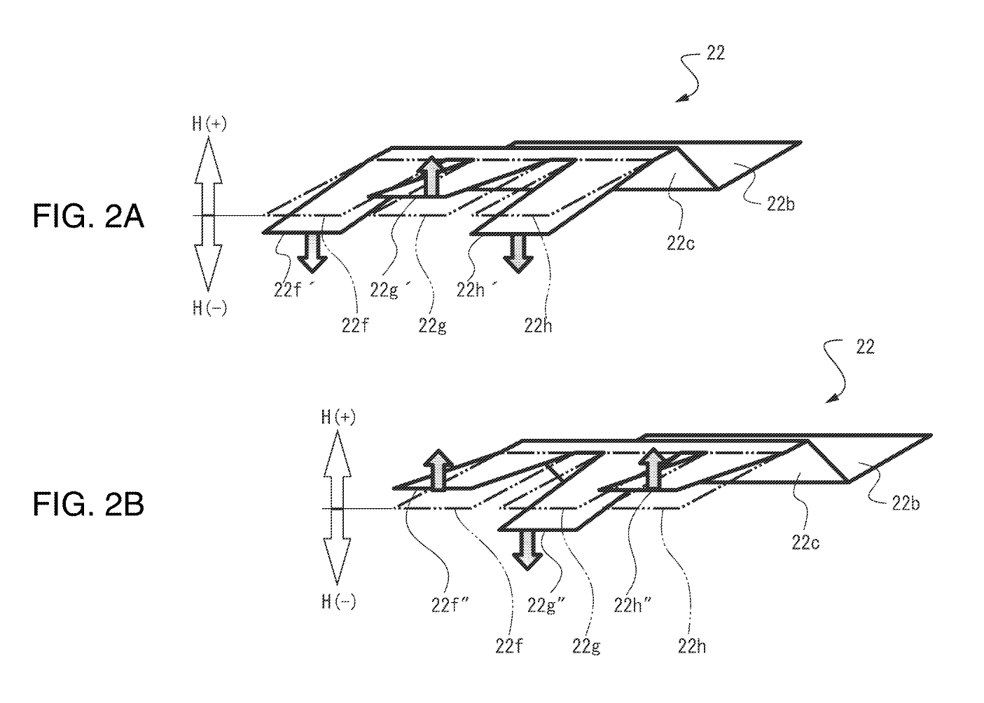

FIGS. 2A and 2B are conceptual views explaining the behavior of the driving electrodes 22f, 22g, and 22h included in the upper electrode 22a in a state where the MEMS vibrator 20 is driven. In the driving electrodes 22f, 22g, and 22h of the MEMS vibrator 20 shown in FIG. 2A, when the tip portions of the driving electrodes 22f and 22h adjacent to a central driving electrode 22g are driven in an H(−) direction and deformed so that the driving electrodes 22f and 22h become driving electrodes 22f′ and 22h′, the tip portion of the central driving electrode 22g is deformed in an H(+) direction so that the driving electrode 22g becomes a driving electrode 22g′. By resilience caused by these deformations as shown in FIG. 2B, the tip portion of the central driving electrode 22g is deformed and driven in the H(−) direction so that the driving electrode 22g becomes a driving electrode 22g″, while the tip portions of the driving electrodes 22f and 22h adjacent to the central driving electrode 22g are deformed in a direction opposite from the central driving electrode 22g, that is, in the H(+) direction so that the driving electrodes 22f and 22h become driving electrodes 22f″ and 22h″. By driving the MEMS vibrator 20 in a vibration mode where such deformations are alternately repeated, vibrations on a vibration base portion side of the driving electrodes deformed in opposite directions are cancelled out, and therefore, vibration leakage can be suppressed.

Moreover, only the driving electrodes 22f and 22h may be driven as follows. When the tip portions of the driving electrodes 22f and 22h of the MEMS vibrator 20 shown in FIG. 2A are driven in the H(−) direction and deformed so that the driving electrodes 22f and 22h become the driving electrodes 22f′ and 22h′, the tip portion of the central driving electrode 22g is deformed in the H(+) direction so that the driving electrode 22g becomes the driving electrode 22g′. By resilience caused by these deformations as shown in FIG. 2B, the tip portions of the driving electrodes 22f and 22h are deformed in the H(+) direction so that the driving electrodes 22f and 22h become the driving electrodes 22f″ and 22h″, while the tip portion of the central driving electrode 22g is deformed in the H(−) direction so that the driving electrode 22g becomes the driving electrode 22g″.

Further, only the driving electrode 22g may be driven as follows. When the tip portion of the central driving electrode 22g of the MEMS vibrator 20 shown in FIG. 2B is driven in the H(−) direction and deformed so that the driving electrode 22g becomes the driving electrode 22g″, the tip portions of the driving electrodes 22f and 22h adjacent to the central driving electrode 22g are deformed in a direction opposite from the central driving electrode 22g, that is, in the H(+) direction so that the driving electrodes 22f and 22h become the driving electrodes 22f″ and 22h″. By resilience caused by these deformations as shown in FIG. 2A, the tip portions of the driving electrodes 22f and 22h are deformed in the H(−) direction so that the driving electrodes 22f and 22h become the driving electrodes 22f′ and 22h′, while the tip portion of the central driving electrode 22g is deformed in the H(+) direction so that the driving electrode 22g becomes the driving electrode 22g′.

As described above, in the MEMS vibrator 20 of the MEMS device 100 according to the embodiment, so-called opposite-phase driving is performed in which the driving electrodes 22f and 22h adjacent to the central driving electrode 22g of the three driving electrodes as driving portions vibrate in a direction different from the central driving electrode 22g. By driving the driving electrodes 22f, 22g, and 22h in phase opposition to each other, the vibrations of the driving electrodes 22f, 22g, and 22h are cancelled out at the vibration base portion of the driving electrodes 22f, 22g, and 22h of the upper electrode 22a connected to the support electrode 22c, and therefore, vibration leakage to the support electrode 22c is suppressed. As a result, vibration leakage to the upper electrode wiring portion 22b arranged on the principal plane 10a of the substrate 10 is suppressed, and vibration leakage to the substrate 10 is suppressed.

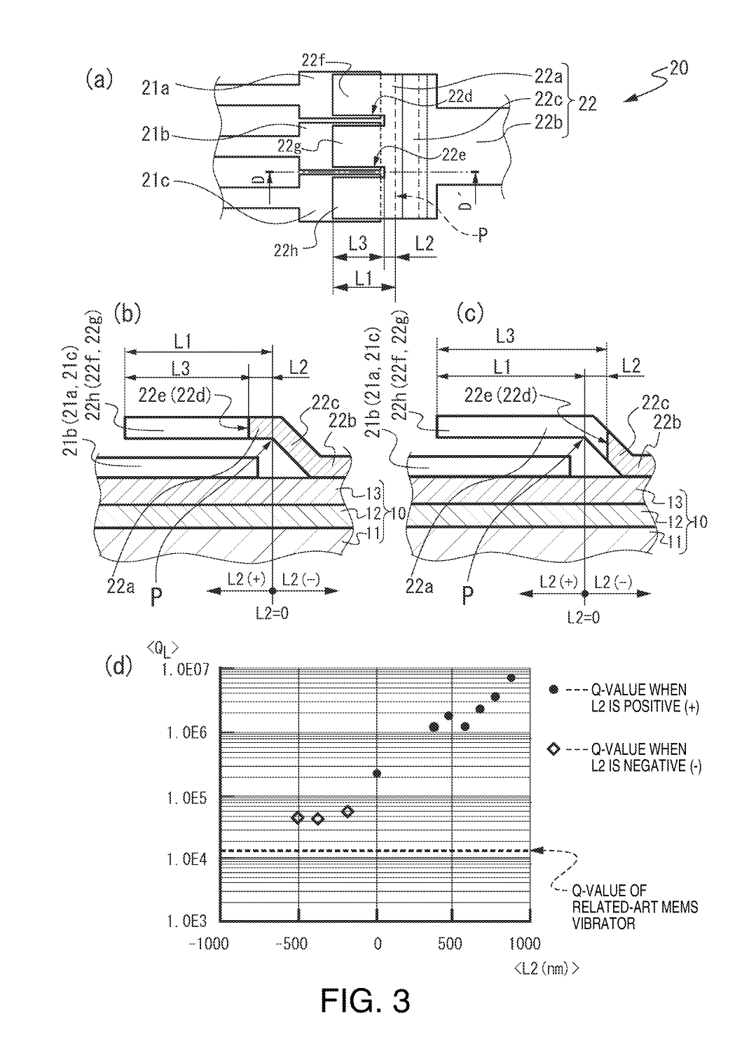

FIG. 3A is a plan view of the MEMS vibrator 20; FIGS. 3B and 3C are enlarged cross-sectional views schematically illustrating the MEMS vibrator 20 in a cross-section of a portion D-D′ shown in FIG. 3A; and FIG. 3D is a graph showing the relation between a Q-value (Q_{L}) in view only of vibration leakage and the form of the notch.

The notches 22d and 22e dividing the electrode into the driving electrodes 22f, 22g, and 22h included in the upper electrode 22a shown in FIG. 3A are arranged as follows on the side facing the lower electrodes 21a, 21b, and 21c of the second conductive layer 22 shown in FIGS. 3B and 3C on the basis of an intersection P of the upper electrode 22a with the support electrode 22c.

First, as shown in FIG. 3B, when the notches 22d and 22e are arranged on the upper electrode 22a side of the intersection P, or the notches 22d and 22e are arranged in the area of the upper electrode 22a to arrange the driving electrodes 22f, 22g, and 22h, that is, when a distance L2 from the intersection P to the notches 22d and 22e satisfies the condition: L2≧0, or L2 is positive (+), it is possible as shown in FIG. 3D to obtain the MEMS vibrator 20 showing a high Q-value (Q_{L}) with suppressed vibration leakage, like the values indicated by black circles where L2 is positive (+), and having a stable oscillation frequency.

Moreover, as shown in FIG. 3C, even when the notches 22d and 22e are arranged on the support electrode 22c side of the intersection P, or the notches 22d and 22e are arranged in the area of the support electrode 22c to arrange the driving electrodes 22f, 22g, and 22h, that is, even when the distance L2 from the intersection P to the notches 22d and 22e satisfies the condition: L2<0, or L2 is negative (−), it is possible as shown in FIG. 3D to obtain the MEMS vibrator 20 showing the Q-value (Q_{L}) with suppressed vibration leakage, which is higher than a Q-value of a related-art MEMS vibrator like the values indicated by white diamonds where L2 is negative (−), and having a stable oscillation frequency.

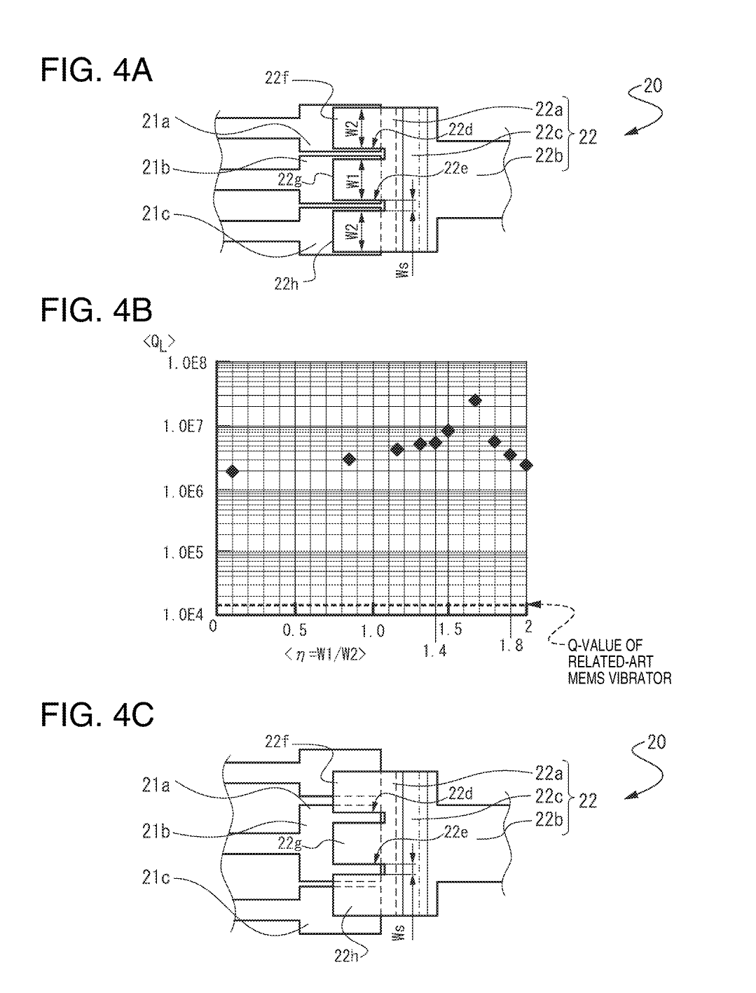

FIG. 4A is a plan view of the MEMS vibrator 20; and FIG. 4B is a graph showing the relation between the Q-value (Q_{L}) in view only of vibration leakage and the width of the driving electrode. As shown in FIG. 4A, in the MEMS vibrator 20 in which the driving electrodes 22f and 22h adjacent to the central driving electrode 22g are driven in phase opposition to the central driving electrode 22g, when η=W1/W2 where W1 is the electrode width of the central driving electrode 22g as a first driving electrode and W2 is the width of the driving electrodes 22f and 22h as second driving electrodes adjacent to the central driving electrode 22g, the width W1 of the driving electrode 22g and the width W2 of the driving electrodes 22f and 22h are set under the condition: 0.1≦η≦2.0 as can be seen from the Q-value (Q_{L}) graph shown in FIG. 4B, whereby it is possible to obtain the MEMS vibrator 20 showing the Q-value (Q_{L}) with suppressed vibration leakage, which is higher than the Q-value of the related-art MEMS vibrator, and having a stable oscillation frequency.

Further, under the condition: 1.4≦η≦1.8, a MEMS vibrator having a higher Q-value (Q_{L}) can be obtained. A width Ws of the notches 22d and 22e is formed preferably to have the manufacturable minimum width for strongly suppressing vibration leakage.

The overlapping form of the lower electrodes 21a, 21b, and 21c and the driving electrodes 22f, 22g, and 22h, in plan view, in the MEMS vibrator 20 shown in FIGS. 1A and 4A may be the form shown in FIG. 4C. As shown in FIG. 4C, the lower electrode 21b corresponding to the central driving electrode 22g has an area facing the driving electrode 22f that is partially adjacent to the driving electrode 22g in the width direction. Similarly, the lower electrode 21b has an area facing the driving electrode 22h that is partially adjacent to the driving electrode 22g in the width direction. Even when the lower electrodes 21a, 21b, and 21c are arranged as described above, it is possible to obtain the MEMS vibrator showing the high Q-value (Q_{L}) with suppressed vibration leakage and having a stable oscillation frequency.

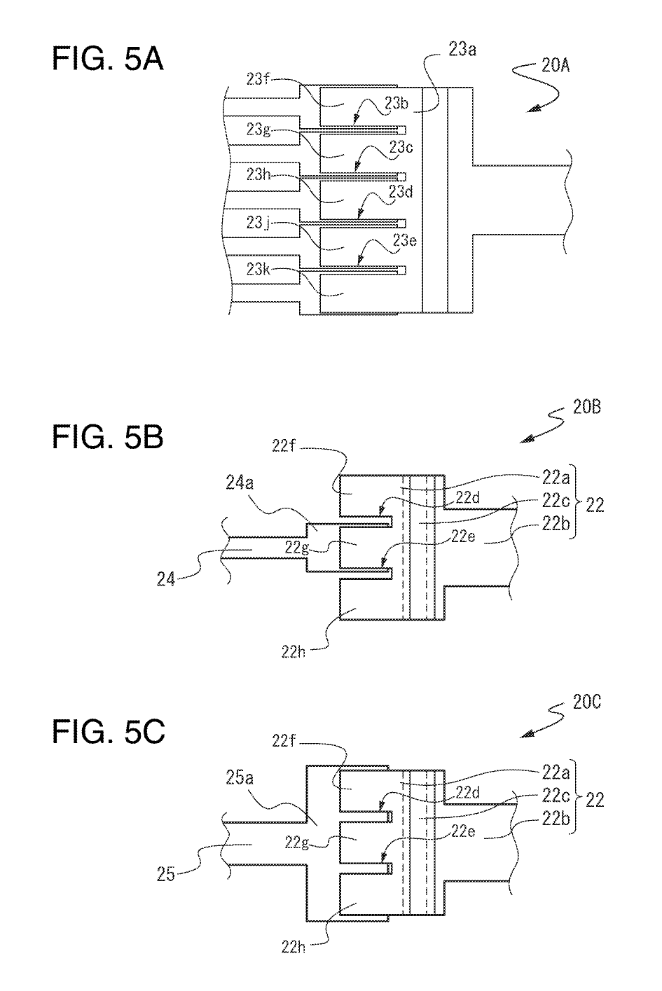

In the MEMS device 100 according to the embodiment, the MEMS vibrator 20 including the three driving electrodes 22f, 22g, and 22h has been illustrated. However, the MEMS vibrator is not limited to this. For example, as shown in FIG. 5A, a MEMS vibrator 20A may be applicable in which four notches 23b, 23c, 23d, and 23e are formed in an upper electrode 23a to provide five driving electrodes 23f, 23g, 23h, 23j, and 23k.

In the MEMS vibrator 20A of this form, driving electrodes adjacent to each other are driven in phase opposition. The driving electrodes 23g and 23j adjacent to the central driving electrode 23h are driven in phase opposition to the driving electrode 23h, and the driving electrode 23f adjacent on one side to the driving electrode 23g is driven in phase opposition to the driving electrode 23g. That is, the driving electrode 23h and the driving electrode 23f are driven in phase with each other. Similarly, the driving electrode 23k adjacent on one side to the driving electrode 23j is driven in phase opposition to the driving electrode 23j. That is, the driving electrode 23h and the driving electrode 23k are driven in phase with each other.

Since the driving electrodes 23f, 23g, 23h, 23j, and 23k are driven as described above, each other's vibration directions are canceled out at the vibration base of the driving electrodes 23f, 23g, 23h, 23j, and 23k. Therefore, it is possible to obtain the MEMS vibrator 20A having a high Q-value with suppressed vibration leakage. The electrode width of each of the driving electrodes 23f, 23g, 23h, 23j, and 23k is set such that the driving electrodes adjacent to each other satisfy the above-described condition based on FIGS. 4A and 4B. However, the widths of the driving electrodes 23f, 23g, 23h, 23j, and 23k are preferably set the same.

A MEMS vibrator 20B shown in FIG. 5B differs from the MEMS vibrator 20 according to the first embodiment in the form of the first conductive layer 21. That is, a first conductive layer 24 includes a lower electrode 24a corresponding to the central driving electrode 22g of the driving electrodes 22f, 22g, and 22h included in the upper electrode 22a of the second conductive layer 22. In the MEMS vibrator 20B configured as described above, the central driving electrode 22g is driven, but the driving electrodes 22f and 22h adjacent to the driving electrode 22g are not driven. However, since a mode is utilized in which the driving electrodes 22f and 22h are deformed in a direction opposite from the central driving electrode 22g, a portion of the vibration of the driving electrode 22g that is driven is canceled out at the vibration base of the driving electrode 22g by the driving electrodes 22f and 22h that are not driven. Therefore, vibration leakage to the substrate 10 can be suppressed. As described above, even when not all of a plurality of driving electrodes are driven, vibration leakage can be suppressed at the vibration base portion of the electrode that is driven.

As one of other forms, a form shown in FIG. 5C may be applicable. Ina MEMS vibrator 20C shown in FIG. 5C, a lower electrode 25a included in a first conductive layer 25 is arranged to face the driving electrodes 22f, 22g, and 22h of the upper electrode 22a. In the MEMS vibrator 20C configured as described above, charges at the same potential are applied to the driving electrodes 22f, 22g, and 22h, on which an electrostatic force in the same direction at the same timing acts. The total plane area of the driving electrodes 22f and 22h is larger than that of the driving electrode 22g. Therefore, the driving electrodes 22f and 22h are driven so as to be deformed in the far side direction of the paper, while the driving electrode 22g is deformed in the near side direction of the paper. By resilience caused by these deformations, the driving electrodes 22f and 22h are deformed in the near side direction of the paper, while the driving electrode 22g is deformed in the far side direction of the paper. In this case, however, since an electrostatic force in the far side direction of the paper acts on the driving electrode 22g when the driving electrodes 22f and 22h are driven so as to be deformed in the far side direction of the paper, a vibration efficiency is deteriorated. However, the first conductive layer 25 is easily prepared.

### Second Embodiment

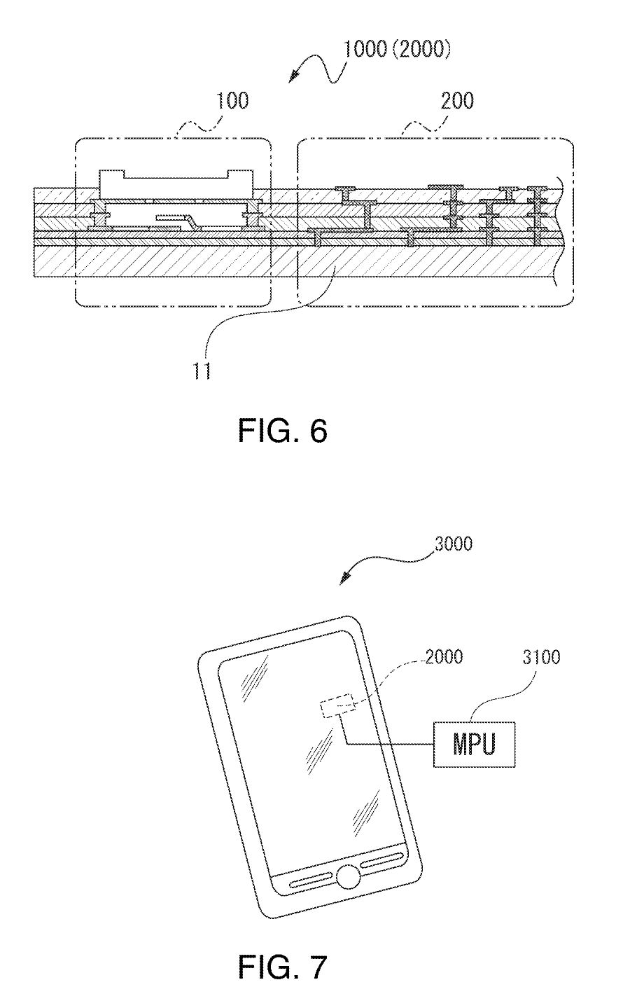

As an electronic device according to a second embodiment, FIG. 6 shows a form in which the MEMS device 100 according to the first embodiment and a semiconductor device are made into one chip. In an oscillator 1000 as the electronic device shown in FIG. 6, the MEMS device 100 according to the first embodiment and a semiconductor device 200 (hereinafter referred to as IC 200) in which an electronic circuit including an oscillator circuit or a control circuit is configured are integrally arranged.

Since the MEMS device 100 is a micro device that can be manufactured by a semiconductor manufacturing method using a semiconductor manufacturing apparatus, the IC 200 can be easily formed on the same wafer substrate 11 as that of the MEMS device 100. The IC 200 includes an oscillator circuit that drives the MEMS device 100 and a control circuit that performs driving for frequency fluctuations of the MEMS device 100 or control of output signals to the outside. By forming the IC 200 and the MEMS device 100 into one chip as described above, the oscillator 1000 having a small size can be obtained. Moreover, by allowing the IC 200 to include an arithmetic circuit that computes an acceleration from vibrations of the MEMS vibrator 20, a small-sized gyro sensor 2000 can be easily obtained.

### Third Embodiment

As electronic apparatuses according to a third embodiment, a smartphone and a digital still camera including the oscillator 1000 or the gyro sensor 2000 according to the second embodiment will be described.

FIG. 7 is an external view showing a smartphone 3000. Into the smartphone 3000, the oscillator 1000 (not shown) as a reference clock oscillation source and the gyro sensor 2000 that detects the attitude of the smartphone 3000 are incorporated. By incorporating the gyro sensor 2000, so-called motion sensing is carried out, so that the attitude of the smartphone 3000 can be detected. Detection signals of the gyro sensor 2000 are supplied to, for example, a micro computer chip 3100 (hereinafter referred to as MPU 3100). The MPU 3100 can execute various types of processing according to the motion sensing. In addition, the motion sensing can be utilized by incorporating the gyro sensor 2000 into an electronic apparatus such as a mobile phone, a portable game console, a game controller, a car navigation system, a pointing system, a head-mounted display, or a tablet personal computer.

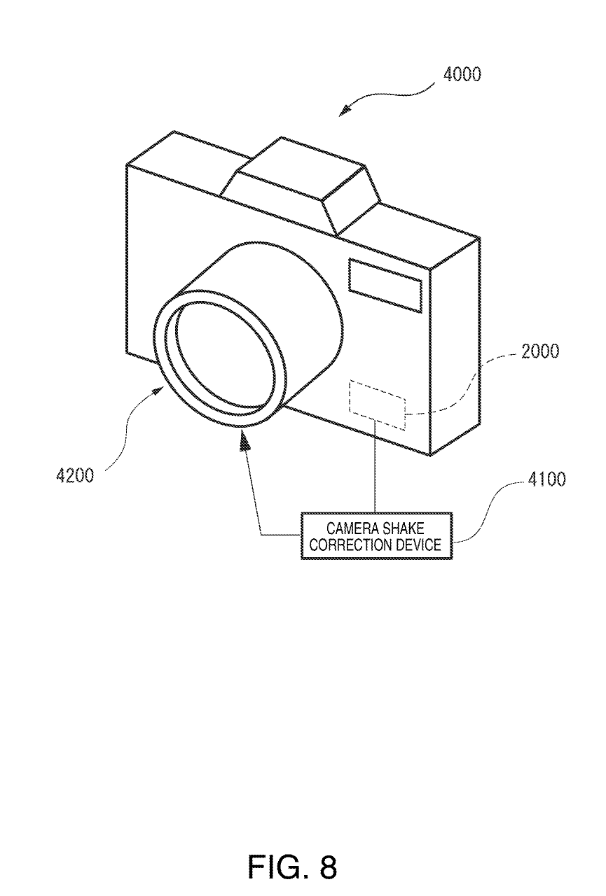

FIG. 8 is an external view showing a digital still camera 4000 (hereinafter referred to as camera 4000). Into the camera 4000, the oscillator 1000 (not shown) as a reference clock oscillation source and the gyro sensor 2000 that detects the attitude of the camera 4000 are incorporated. Detection signals of the incorporated gyro sensor 2000 are supplied to a camera shake correction device 4100. The camera shake correction device 4100 can move, for example, a specific lens in a lens set 4200 according to the detection signals of the gyro sensor 2000 to suppress an image defect due to camera shake. Moreover, by incorporating the gyro sensor 2000 and the camera shake correction device 4100 into a digital video camera, a camera shake correction can be made similarly to the camera 4000.

### Fourth Embodiment

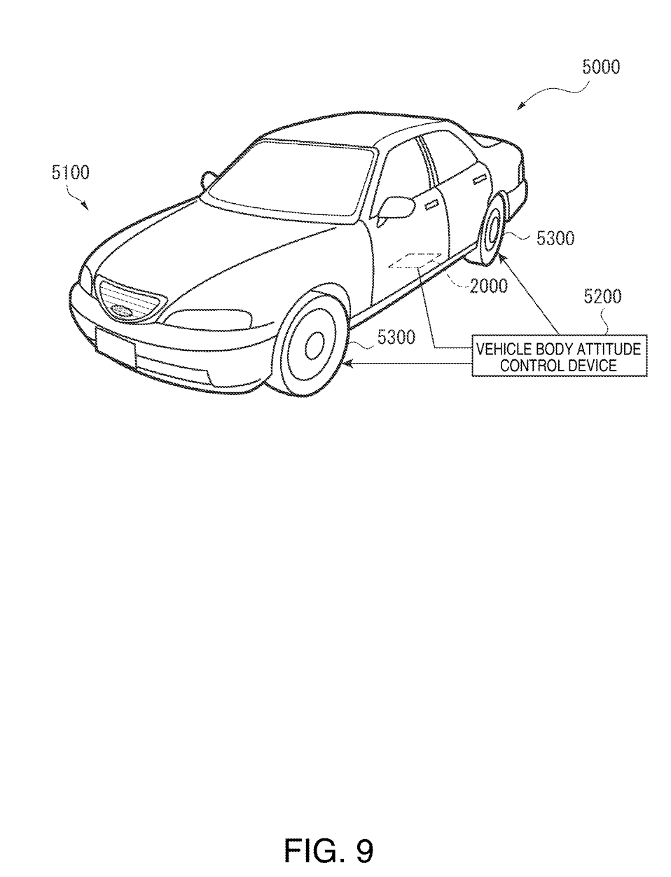

As a specific example of a moving object as a fourth embodiment including the oscillator 1000 or the gyro sensor 2000 according to the second embodiment, an automobile will be described. FIG. 9 is an external view of an automobile 5000 according to the fourth embodiment. As shown in FIG. 9, the gyro sensor 2000 is incorporated into the automobile 5000. The gyro sensor 2000 detects the attitude of a vehicle body 5100. Detection signals of the gyro sensor 2000 are supplied to a vehicle body attitude control device 5200. The vehicle body attitude control device 5200 can compute, based on the supplied signals, an attitude state of the vehicle body 5100 to control, for example, the hardness and softness of a shock absorber (so-called suspension) according to the attitude of the vehicle body 5100 or control the braking force of individual wheels 5300. The attitude control using the gyro sensor 2000 described above can be utilized for a bipedal walking robot, an aircraft, or a toy such as a radio-controlled helicopter.

In the automobile 5000 of FIG. 9, the MEMS device 100 according to the first embodiment is used as a timing device that generates a reference clock for various types of electronic control units (not shown, and for example, an electrically controlled fuel injector, an electrically controlled ABS unit, an electrically controlled cruise controller, and the like) mounted on the automobile. Moreover, a moving object including the oscillator 1000 according to the second embodiment is not limited to the automobile 5000. The oscillator 1000 according to the second embodiment can be preferably used as a timing device for moving objects including a self-propelled robot, self-propelled carrier equipment, a train, a ship, an airplane, and a satellite. In any of these cases, it is possible to provide a moving object in which the advantageous effects described in the embodiments are reflected.

The entire disclosure of Japanese Patent Application No. 2013-040409, filed Mar. 1, 2013 is expressly incorporated by reference herein.

What is claimed is:

1. A MEMS device comprising:
a substrate; and
a vibrator, wherein
the vibrator includes
a first fixed electrode located above a principal plane of the substrate,
an upper electrode spaced apart from the first fixed electrode and having an area overlapping the first fixed electrode as viewed in a normal direction of the principal plane, and
a support electrode connected to one edge of the upper electrode, and
the upper electrode includes a plurality of driving electrodes divided by at least one slit-shaped notch extending in a direction from the other edge of the upper electrode to the support electrode.

2. A MEMS device comprising:
a substrate; and
a vibrator, wherein
the vibrator includes
a first conductive layer arranged above a principal plane of the substrate and including a first fixed electrode, and
a second conductive layer including an upper electrode and a support electrode, the upper electrode being spaced apart from the first fixed electrode, having an area overlapping the first fixed electrode as viewed in a normal direction of the principal plane, and extending along the principal plane, the support electrode connecting a second fixed electrode connected to the principal plane with one edge of the upper electrode, and supporting the upper electrode, and
the upper electrode includes a plurality of driving electrodes divided by at least one slit-shaped notch extending in a direction from a vibration tip portion to a vibration base portion, the vibration base portion being the one edge of the upper electrode, the vibration tip portion being the other edge of the upper electrode.

3. The MEMS device according to claim 1, wherein
the first fixed electrode includes a plurality of electrode portions overlapping the plurality of driving electrodes as viewed in the normal direction of the principal plane.

4. The MEMS device according to claim 2, wherein
an end of the notch in the vibration base portion direction is present in the area of the support electrode.

5. The MEMS device according to claim 2, wherein
an end of the notch in the vibration base portion direction is present in the area of the upper electrode.

6. The MEMS device according to claim 1, wherein
the notch is arranged at two or more even numbered places, and
vibration directions of the driving electrodes adjacent to each other with the notch interposed therebetween are opposite from each other.

7. The MEMS device according to claim 2, wherein
the notch is arranged at two or more even numbered places, and
vibration directions of the driving electrodes adjacent to each other with the notch interposed therebetween are opposite from each other.

8. The MEMS device according to claim 1, wherein
the notch is arranged at two places, and
the driving electrodes include a first driving electrode arranged between the notches and two second driving electrodes each adjacent to the first driving electrode with the notch interposed therebetween, and
the condition: 0.1≦W1/W2≦2.0 is satisfied where W1 is the width of the first driving electrode and W2 is the width of the second driving electrode.

9. The MEMS device according to claim 2, wherein
the notch is arranged at two places, and
the driving electrodes include a first driving electrode arranged between the notches and two second driving electrodes each adjacent to the first driving electrode with the notch interposed therebetween, and
the condition: 0.1≦W1/W2≦2.0 is satisfied where W1 is the width of the first driving electrode and W2 is the width of the second driving electrode.

10. The MEMS device according to claim 8, wherein
the condition: 1.4≦W1/W2≦1.8 is satisfied.

11. The MEMS device according to claim 9, wherein
the condition: 1.4≦W1/W2≦1.8 is satisfied.

12. An electronic device comprising:
the MEMS device according to claim 1; and
a control circuit including a circuit driving the MEMS device.

13. An electronic device comprising:
the MEMS device according to claim 2; and
a control circuit including a circuit driving the MEMS device.

14. An electronic apparatus comprising the MEMS device according to claim 1.

15. An electronic apparatus comprising the MEMS device according to claim 2.

16. A moving object comprising the MEMS device according to claim 1.

17. A moving object comprising the MEMS device according to claim 2.
